(19) United States
(12) Patent Application Publication
(10) Pub. No.: US 2018/0229381 A1
(43) Pub. Date: Aug. 16, 2018

(54) REPLACEABLE BLADE

(71) Applicant: Hao LEE, New Taipei City (TW)

(72) Inventor: Hao LEE, New Taipei City (TW)

(21) Appl. No.: 15/430,444

(22) Filed: Feb. 10, 2017

(51) Int. Cl. B26B 9/00; B26B 5/00

(52) U.S. Cl. CPC B26B 9/00; B26B 5/00

(57) ABSTRACT

A replaceable blade includes a blade provided in a long-strip shape. One side of the blade has a plurality of score lines, and each of the score lines is extended from two side edges and crossed the blade. Each score line includes a plurality of groove segments arranged collinearly, and the groove segments of each of the line scores are spaced apart from each other in a longitudinal direction of the score line. The replaceable blade has score lines in dashed line shapes to prevent an unexpected broken from happening.

### BACKGROUND OF THE INVENTION

### Field of the Invention

The present invention generally relates to a blade and, more particular to, a replaceable blade with score lines.

### Description of Prior Art

A conventional replaceable blade usually has a plurality of score lines on a side of the blade thereof; therefore, when the tip of the blade is blunt, users can break the blade easily along the score line to form a new tip.

The deeper the score line is, the easier the blade breaks. However, in the meantime, the structures of that portion of the blade also become weak so that it is easy to be broken by accident when the blade is used for cutting or being dropped on the ground. Moreover, the blades nowadays can be made of ceramic, and that is more brittle to be broken at the score lines than old metal blades.

In view of the above drawbacks, the Inventor proposes the present invention based on his expert knowledge and elaborate researches in order to solve the problems of prior art.

### SUMMARY OF THE INVENTION

Accordingly, an object of the present invention is to provide a replaceable blade having score lines in dashed line shapes to prevent an unexpected broken from happening.

The present invention provides a replaceable blade including a blade provided in a long-strip shape. One side of the blade has a plurality of score lines, and each of the score lines is extended from two side edges and crossed the blade. Each score line comprises a plurality of groove segments arranged collinearly, and the groove segments of each of the line score are spaced apart from each other in a longitudinal direction of the score line.

The present invention provides a replaceable blade, wherein one side of the blade is formed with a cutting edge, and another side of the blade is formed with a back edge with respect to the cutting edge. The depths of the score lines near the cutting edge are shallower than the depths of the score lines near the back edge. The depths of the groove segments of the score line near the cutting edge are shallower than the depths of the groove segments of the score lines near the back edge. The widths of the score lines near the cutting edge are narrower than the widths of the score lines near the back edge. The widths of the groove segments of the score lines near the cutting edge are narrower than the widths of the groove segments of the score lines near the back edge. Each of the score lines is configured in a V shape. The blade is made of metal or ceramic. Moreover, another side of the blade has another a plurality of score lines positioned corresponding the score lines. One end of blade is formed with a tip, and another end of the blade is provided with an installation aperture.

Compared to the prior art, the replaceable blade of the present invention has a plurality of groove segments of each score line as to constitute the score line in a dashed line. Thus the groove segments will not too weak to be broken in an unexpected operation.

### BRIEF DESCRIPTION OF DRAWING

The features of the invention believed to be novel are set forth with particularity in the appended claims. The invention itself, however, may be best understood by reference to the following detailed description of the invention, which describes a number of exemplary embodiments of the invention, taken in conjunction with the accompanying drawings, in which:

FIG. 1 is a perspective schematic view of the replaceable blade of a preferred embodiment of the present invention;

FIG. 2 is a partial enlarged schematic view of the replaceable blade of a preferred embodiment of the present invention;

FIG. 3 is a longitudinal sectional view of the replaceable blade in FIG. 2 along a line 3-3;

FIG. 4 is a cross sectional view of the replaceable blade in FIG. 2 along a line 4-4.

### DETAILED DESCRIPTION OF THE PREFERRED EMBODIMENTS

In cooperation with attached drawings, the technical contents and detailed description of the invention are described thereinafter according to a number of preferable embodiments, being not used to limit its executing scope. Any equivalent variation and modification made according to appended claims is all covered by the claims claimed by the present invention.

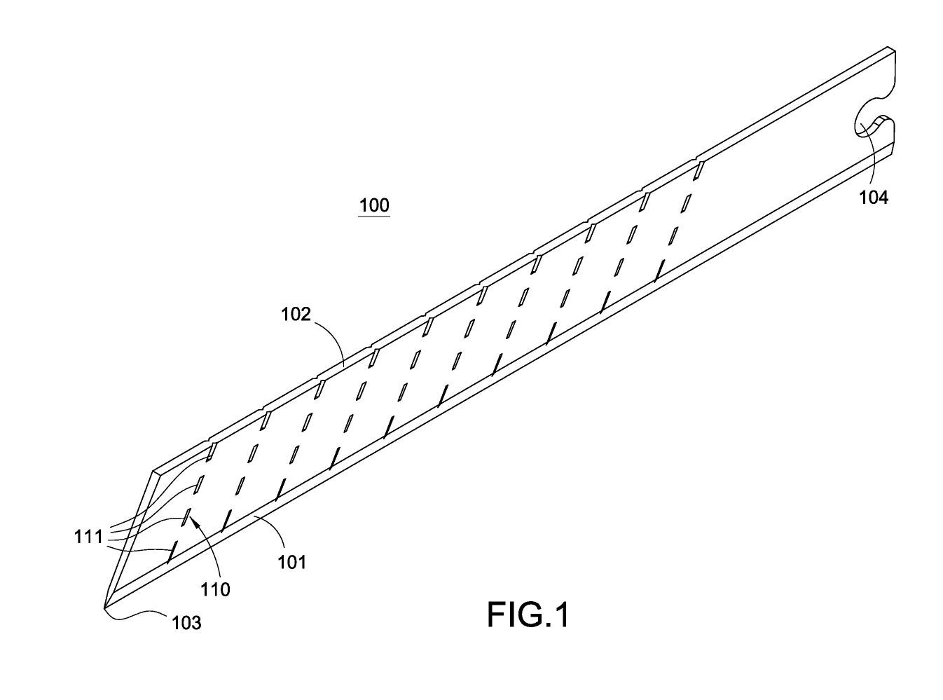

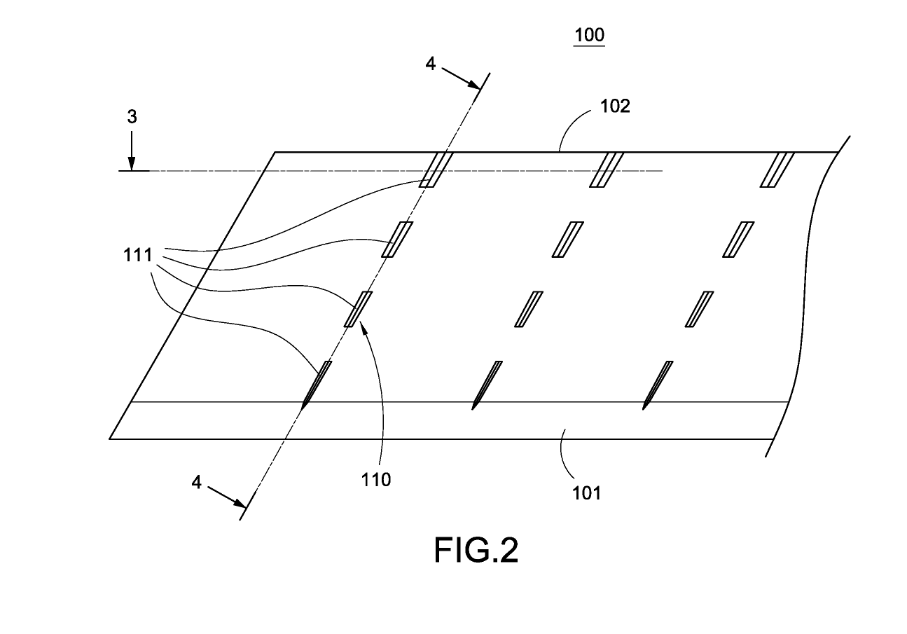

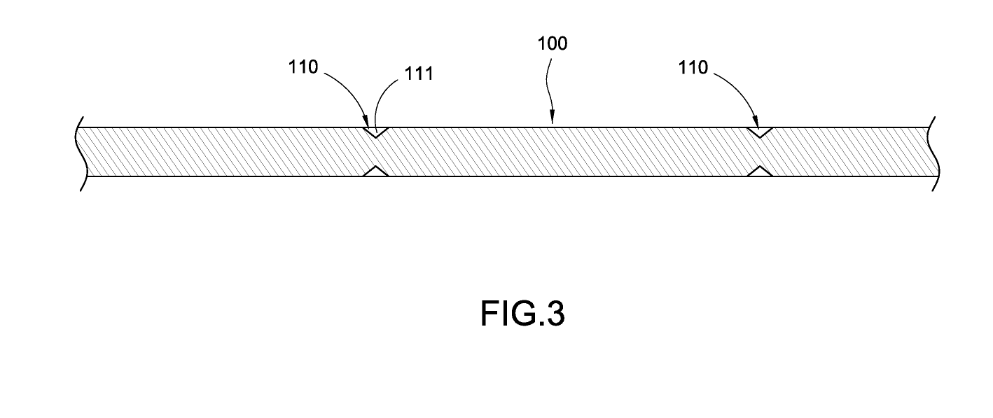

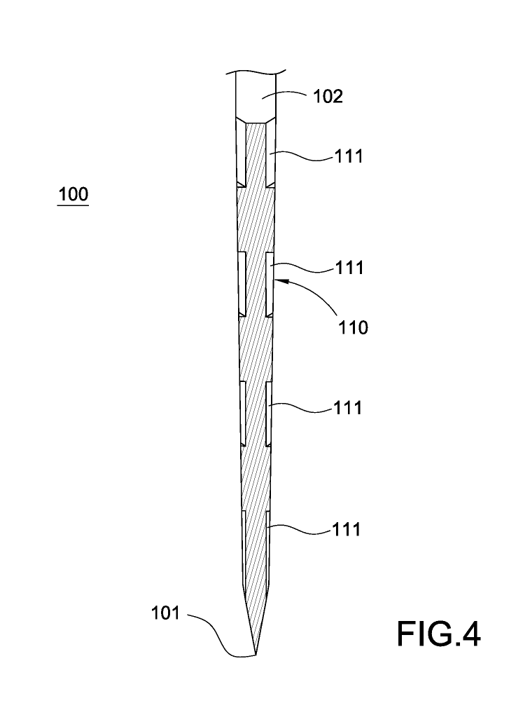

Please refer to FIG. 1 to FIG. 4. A preferred embodiment of the present invention provides a replaceable blade installed in a handle (not shown). In the present invention, the replaceable blade of the present invention includes a blade 100, and the blade 100 can be made of metal, ceramic or blend materials, and the present invention is not limited thereto. The blade 100, preferably, is configured in a long-strip shape. One side of the blade 100 is formed with a cutting edge 101 in an edge of the blade 100 longitudinally, and another side of the blade 100 is formed with a back edge 102 with respect to the cutting edge 100. Besides, one end of blade 100 is a beveled break and formed with a tip 103 at the end of the cutting edge 101. In addition, another end of the blade 100 is provided with an installation aperture 104 for the blade 100 installing in the handle.

One side of the blade 100 has provided with a plurality of score lines 110, and each of the score lines 110 is extended from two side edges of the blade 100 and crossed the blade 100. Each of the score lines 100 is inclined with respect to the longitudinal direction of the blade 100 respectively, and the score lines 100 are preferably spaced apart from each other from an end of the tip 103. Therefore, a new tip 103 will be formed at the cutting edge 101 after each score line 110 is broken.

Furthermore, each of the score lines 100 is configured in a V shape. Each score line 110 comprises a plurality of groove segments 111 arranged collinearly, and each of the groove segments 111 of the line score 110 is preferably also configured in a V shape. For comparison with rectangular grooves in the prior art, stress concentrations are formed at corners of the rectangular groove when users break the blade 100. Thus the breaking location can be happed at different corners of the rectangular grooves so that the broken edge is not flat. In the present invention, the line score 110 is configured in a V shape, and a single corner is formed at the bottom of the groove. Hence, there is only one stress concentration, and the broken edge will be flat when users break the blade 100.

The depths of the score lines 100 near the cutting edge 100 are shallower than the depths of the score lines 110 near the back edge 102. Preferably, the depths of the groove segments 111 of the score lines 110 near the cutting edge 101 are shallower than the depths of the groove segments 111 of the score lines 110 near the back edge 102. And more preferably, the widths of the groove segments 111 of the score lines 110 near the cutting edge 101 are narrower than the widths of the groove segments 111 of the score lines 110 near the back edge 102. Therefore, the structure strength of the blade 100 can be evenly distributed along the longitudinal directions of the segment grooves 110.

Preferably, another side of the blade 100 can optionally has another a plurality of score lines 110 positioned corresponding the score lines 110 for utilizing the score lines 110 easily, but the present invention is not limited thereto. Preferably, the positions of the groove segments 111 are also corresponded per each pair of the corresponding score lines 110 on two sides of the blade 100. Therefore, the break locations of the two sides of the blade 100 will be corresponded to ensure that the broken edge is flat.

In the present embodiment, each of the score lines has a plurality of groove segments for constituting score lines 110 in dashed line shapes. The blade 100 between the groove segments 110 still has a considerable structural strength, and then the groove segments 110 will not too weak as to break in an unexpected operation. Therefore, in addition to the traditional metal blades, it can be applied to a ceramic replacement blade with a harder and more brittle property.

Although the present invention has been described with reference to the preferred embodiment thereof, it will be understood that the invention is not limited to the details thereof. Various substitutions and improvements have been suggested in the foregoing description, and others will occur to those of ordinary skill in the art. Therefore, all such substitutions and improvements are intended to be embraced within the scope of the invention as defined in the appended claims.

What is claimed is:

1. A replaceable blade including a blade provided in a long-strip shape; one side of the blade having a plurality of score lines, and each of the score lines extended from two side edges and crossed the blade; each of the score lines comprising a plurality of groove segments arranged collinearly, and the groove segments of each of the line scores being spaced apart from each other in a longitudinal direction of each of the score lines.

2. The blade according to claim 1, wherein one side of the blade is formed with a cutting edge, and another side of the blade is formed with a back edge with respect to the cutting edge.

3. The blade according to claim 2, wherein the depths of the score lines near the cutting edge are shallower than the depths of the score lines near the back edge.

4. The blade according to claim 3, wherein the depths of the groove segments of the score lines near the cutting edge are shallower than the depths of the groove segments of the score lines near the back edge.

5. The blade according to claim 2, wherein the widths of the groove segments of the score lines near the cutting edge are narrower than the widths of the groove segments of the score lines near the back edge.

6. The blade according to claim 5, wherein the widths of the groove segments of the score lines near the cutting edge are narrower than the widths of the groove segments of the score lines near the back edge.

7. The blade according to claim 1, wherein each of the score lines is configured in a V shape.

8. The blade according to claim 1, wherein the blade is made of metal.

9. The blade according to claim 1, wherein the blade is made of ceramic.

10. The blade according to claim 1, wherein another side of the blade has another a plurality of score lines positioned corresponding the score lines.

11. The blade according to claim 1, wherein one end of blade is formed with a tip, and another end of the blade is provided with an installation aperture.
